(19) United States
(12) Patent Application Publication
(10) Pub. No.: US 2026/0252839 A1
(43) Pub. Date: Aug. 27, 2026

(54) RFID TAG

(71) Applicant: DAIO PAPER CORPORATION, Ehime (JP)

(72) Inventors: Takuro SHIMADA, Ehime (JP); Alina KAN, Ehime (JP); Tsubasa SASAKI, Ehime (JP)

(21) Appl. No.: 18/876,865

(22) PCT Filed: Jun. 9, 2023
(86) PCT No.: PCT/JP2023/021520

§ 371 Date: Dec. 19, 2024

(30) Foreign Application Priority Data
Jul. 8, 2022 (JP) 2022-110295

(51) Int. Cl. G06K 19/077; H01Q 1/22

(52) U.S. Cl. CPC G06K 19/07773; H01Q 1/2225

(57) ABSTRACT

An RFID tag includes: an IC chip in which identification information is recorded; a loop-shaped conductor formed in an annular shape including a pair of shorter sides that extend in a shorter direction of the RFID tag and are situated to face both ends of the RFID tag in a longer direction of the RFID tag, the loop-shaped conductor being connected to the IC chip; and a pair of rectangular conductors extending from the pair of shorter sides to both sides in the longer direction and formed in a rectangular shape.

### TECHNICAL FIELD

This disclosure relates to an RFID tag.

### BACKGROUND ART

There is a known method of pasting a Radio Frequency Identification (RFID) tag on a management target article and reading and writing information about the article from and into the tag to manage the article with high accuracy and simplicity.

For example, PTL 1 discloses a configuration for pasting an RFID tag on a book cover or the like during bookbinding to be used for book management.

### CITATION LIST

### Patent Literature

PTL 1: Japanese Patent Application Laid-Open Publication No. 2002-326474

### SUMMARY OF THE INVENTION

### Technical Problem

In general, books are made by binding multiple sheets of paper. It often happens that many books are collectively laid on their side when they are sold or stored in a bookstore, or when they are stored in a library. For this reason, for example, when RFID tags are pasted on a cover portion, such as the front cover or the back cover, or on the endleaf or the title page close to the cover portion, the RFID tags of the books laid on their side may be in a position to be sandwiched between the upper and lower books. In such a position, the communication distance of the RFID tags may be shortened due to the effect of close positioning of the RFID tags pasted on the books, or the effect of moisture contained in the multiple sheets of paper forming the books, and the RFID tag reading accuracy may deteriorate. The same problem may also occur when a plurality of books are arranged side by side closely to each other on a bookshelf.

It is an object of the present disclosure to provide an RFID tag capable of inhibiting deterioration in the communication performance.

### Solution to the Problem

An RFID tag according to an aspect of an embodiment of the present invention includes: an Integrated Circuit (IC) chip in which identification information is recorded; a loop-shaped conductor formed in an annular shape including a pair of opposite sides that extend in a shorter direction of the RFID tag and are situated to face both ends of the RFID tag in a longer direction of the RFID tag, the loop-shaped conductor being connected to the IC chip; and a pair of rectangular conductors extending from the pair of opposite sides to both sides in the longer direction and formed in a rectangular shape.

According to this aspect, it is possible to inhibit deterioration in the communication performance by forming a conductor pattern including a loop-shaped conductor and rectangular conductors.

In the RFID tag according to another aspect of the embodiment of the present invention, each of the pair of rectangular conductors may include: a protrusion that protrudes from at least one of both ends of the rectangular conductor in the shorter direction to an outer side of the loop-shaped conductor in the shorter direction; and a strip that protrudes from the protrusion toward a center in the longer direction along the longer direction and is formed in a strip shape.

According to this aspect, it is possible to better inhibit deterioration in the communication performance by forming a conductor pattern including the protrusion and the strip.

In the RFID tag according to another aspect of the embodiment of the present invention, the loop-shaped conductor may include a pair of second opposite sides extending in the longer direction and situated to face both ends of the RFID tag in the shorter direction, and the strip may include a pair of strips that protrude from the protrusions of the pair of rectangular conductors on one of the pair of second opposite sides.

According to this aspect, it is possible to better inhibit deterioration in the communication performance by forming a conductor pattern including the pair of strips.

In the RFID tag according to another aspect of the embodiment of the present invention, the strip may include another pair of strips that protrude from the protrusions of the pair of rectangular conductors on the other of the pair of second opposite sides.

According to this aspect, it is possible to better inhibit deterioration in the communication performance by forming a conductor pattern including two pairs of strips.

In the RFID tag according to another aspect of the embodiment of the present invention, the strip may be formed so as not to overlap a portion of the loop-shaped conductor at which the IC chip is installed when viewed in the shorter direction.

According to this aspect, it is possible to better inhibit deterioration in the communication performance by forming the strip in this manner.

### Advantageous Effects of the Invention

According to the present disclosure, it is possible to provide an RFID tag capable of inhibiting deterioration in the communication performance.

### BRIEF DESCRIPTION OF THE DRAWINGS

FIG. 1 is a cross-sectional view of laminated layers of an RFID tag according to an embodiment.

FIG. 2 is a plan view of the RFID tag shown in FIG. 1 as viewed from above.

FIG. 3 is a view showing an example of the dimension of each part of a conductor pattern of the inlay shown in FIG. 2.

FIG. 4 is a view showing an example of a configuration for pasting an RFID tag according to an embodiment on a book that is a pasting target.

FIG. 5 is a view showing an example of a method for reading information from RFID tags pasted on a plurality of books that are pasting targets.

FIG. 6 is a plan view of an RFID tag according to a first modified example.

FIG. 7 is a plan view of an RFID tag according to a second modified example.

FIG. 8 is a plan view of the RFID tag according to a third modified example.

FIG. 9 is a schematic view of a measurement environment of a first test according to Example 1.

FIG. 10 is a plan view of the measurement environment shown in FIG. 9.

FIG. 11 is a schematic view of a measurement environment of a first test according to Example 2.

FIG. 12 is a schematic view of a measurement environment of a first test according to Example 3.

FIG. 13 is a plan view showing a conductor pattern of RFID tags used in Comparative Examples 1 to 3.

FIG. 14 is a diagram showing the frequency characteristics of Comparative Example 4.

FIG. 15 is a diagram showing the frequency characteristics of Example 4.

FIG. 16 is a diagram showing changes in the number of readable tags of Comparative Example 5.

FIG. 17 is a diagram showing changes in the number of readable tags of Example 5.

FIG. 18 is a diagram showing the frequency characteristics of Example 6.

FIG. 19 is a diagram showing the frequency characteristics of Example 7.

### DETAILED DESCRIPTION OF THE INVENTION

Embodiments will now be described with reference to the accompanying drawings. In order to facilitate understanding of the description, the same reference numerals are assigned to the same components in the drawings to the extent possible, and duplicate descriptions will be omitted.

In the following description, the X, Y, and Z directions are directions perpendicular to each other. The Z direction is the longer direction of each component of an RFID tag 1, such as an inlay 2. The Y direction is the transverse or shorter direction of each component of the RFID tag 1, such as the inlay 2. The Z direction is the lamination direction of each component of the RFID tag, such as the inlay 2. For the sake of description, the positive side on the Z axis may be referred to as the front side of the upper side, and the negative side on the Z axis may be referred to as the back side or the lower side.

### Structure of RFID Tag 1

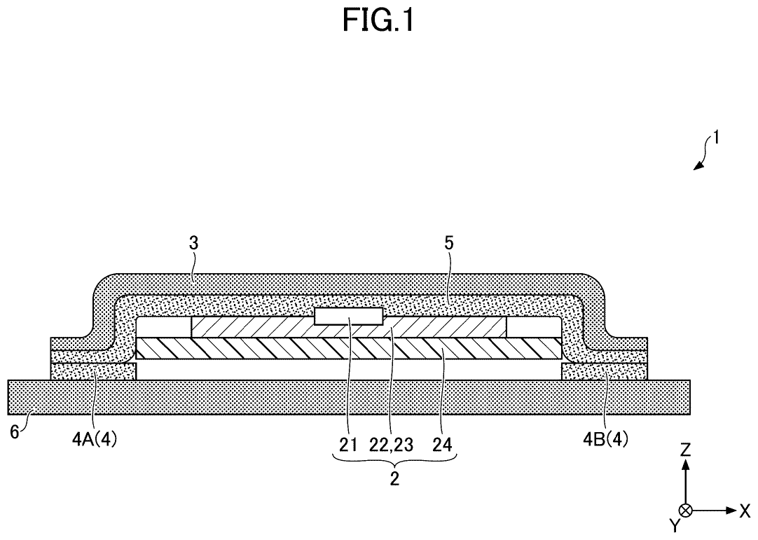

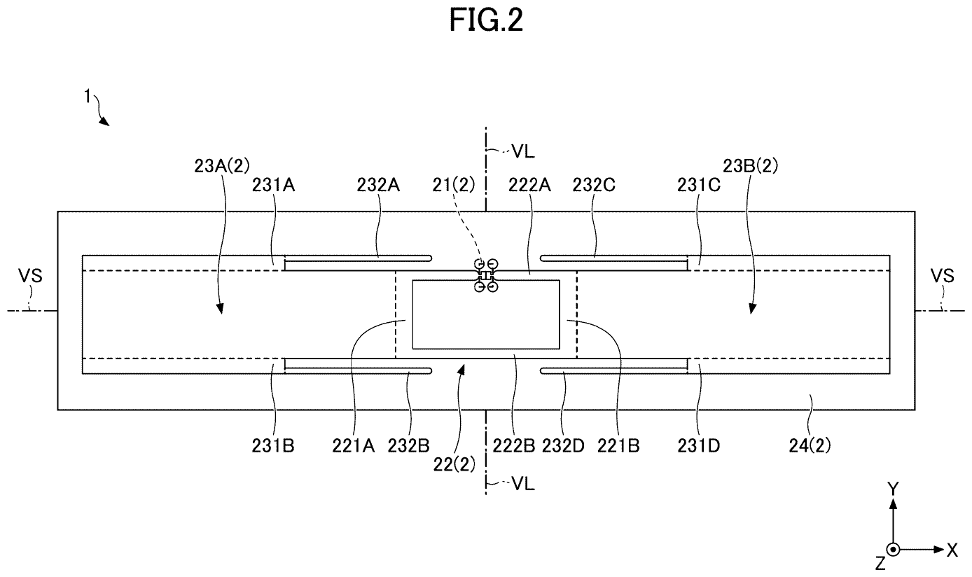

FIG. 1 is a cross-sectional view of laminated layers of the RFID tag 1 according to an embodiment. FIG. 2 is a plan view of the RFID tag 1 shown in FIG. 1 as viewed from above. FIG. 2 shows only elements related to the inlay 2 in FIG. 1. The RFID tag 1 is a substantially planar device to be pasted on a pasting target. As shown in FIGS. 1 and 2, the RFID tag 1 incorporates the inlay 2.

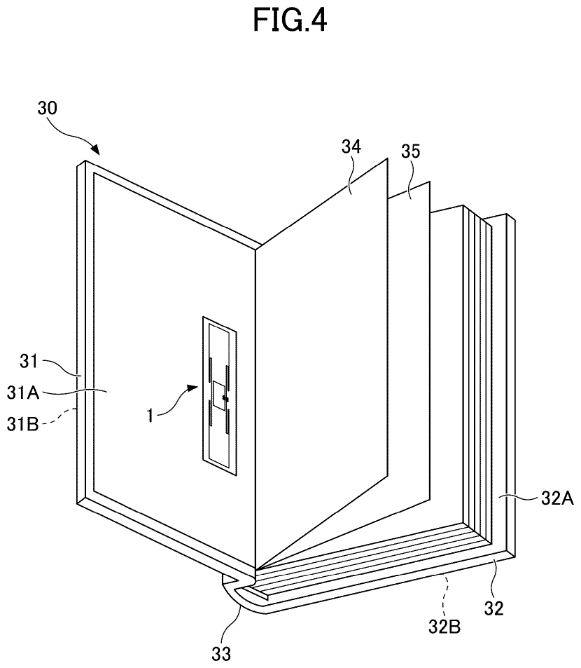

Examples of the pasting target include a book 30, such as a book or a magazine, as will be described later with reference to FIG. 4. The pasting target is not limited to the book 30, but may be an article that is stacked in the vertical or horizontal direction mainly during storage, an article formed by stacking multiple sheets of paper as in the case of the book 30, or an article formed of a material containing moisture such as paper as in the case of the book 30. Examples of such an article include: cards such as trading cards; stationery such as clear files and notebooks; foods such as confectionery; newspapers; tickets; and transportation tickets.

It is preferable that the RFID tag 1 of the present embodiment has flexibility and can be pasted on a pasting target even when the surface of the target is curved. The RFID tag 1 of the present embodiment can exhibit good communication performance even when it is bent in a curved shape, and can also be used to identify an article having a curved surface. Therefore, it is possible to diversify the applications thereof.

The inlay 2 is a part including elements related to the function of the RFID tag 1, and as shown in FIG. 2, includes an IC chip 21 in which identification information is recorded, a loop-shaped conductor 22 connected to the IC chip 21, and a pair of rectangular conductors 23A and 23B. In the following description, the pair of rectangular conductors 23A and 23B may be collectively referred to as “rectangular conductors 23,” and in FIG. 1, they are referred to as such.

The inlay 2 includes the loop-shaped conductor 22 and the rectangular conductors 23 that are formed by pasting an aluminum sheet by dry laminate on a base member 24 made of a synthetic resin film such as polyethylene terephthalate, polypropylene, or the like. The IC chip 21 is mounted at a predetermined position of the inlay.

The IC chip 21 has an internal capacitance. A matching circuit is formed by the inductance of the rectangular conductors 23 and the internal capacitance of the IC chip 21.

The loop-shaped conductor 22 is a conductive wiring pattern having a loop (annular) shape including one turn or less as a planar shape viewed in the Z direction. The loop-shaped conductor 22 needs only to be formed at least in an annular shape including a pair of opposite sides that extend in the transverse or shorter direction (Y direction) of the RFID tag 1 and are situated to face both ends of the RFID tag in the longitudinal or longer direction (X direction). In the present embodiment, the loop-shaped conductor 22 is formed in an annular shape having a rectangular shape including a pair of shorter sides 221A and 221B and a pair of longer sides 222A and 222B, as shown in FIG. 2. In the present embodiment, the pair of shorter sides 221A and 221B function as the “pair of opposite sides” described above.

In the present embodiment, the pair of longer sides 222A and 222B function as a “pair of second opposite sides” that extend in the longer direction (X direction) and are situated to face both ends in the short-side direction (Y direction). Of the pair of shorter sides 221A and 221B, one shorter side 221A is positioned on the negative X direction side (left side in FIG. 2) and the other shorter side 221B is positioned on the positive X direction side (right side in FIG. 2). Of the pair of longer sides 222A and 222B, one loner side 222A is positioned on the positive Y direction side (upper side in FIG. 2) and the other longer side 222B is positioned on the negative Y direction side (lower side in FIG. 2).

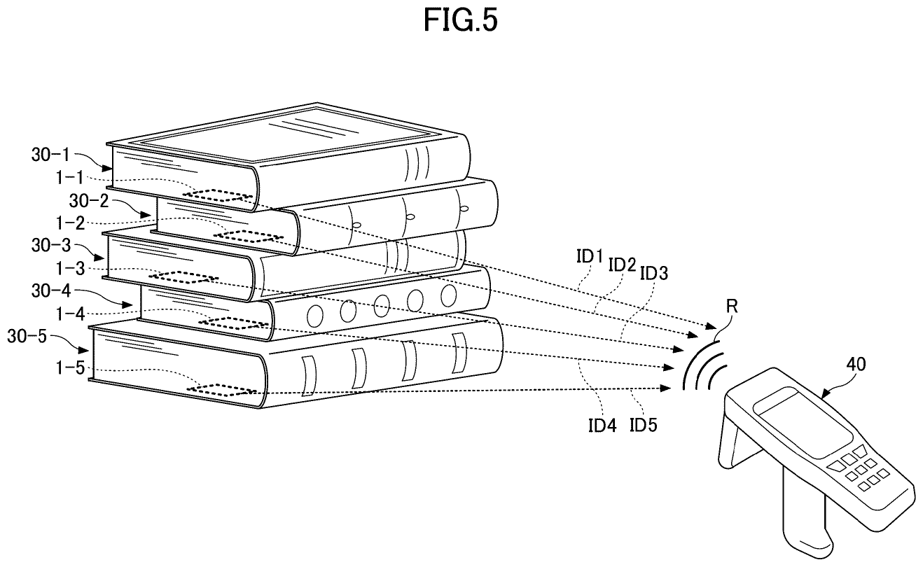

The loop-shaped conductor 22 is electrically connected to the IC chip 21 and the rectangular conductors 23. When reading out the identification information recorded in the IC chip 21 by an RFID reader 40 (see FIG. 5 and the like), upon reception of radio waves in the UHF band, for example, radio waves around 920 MHZ by the rectangular conductors 23 of the inlay 2, a current flows in the loop-shaped conductor 22 due to resonance. As a result, an electromotive force for operating the IC chip 21 is generated. When the IC chip 21 starts to operate, the identification information recorded in the IC chip 21 is encoded by the IC chip 21, and the encoded data is wirelessly transmitted to a communication device such as the RFID reader 40 or the like via a radio wave around 920 MHz serving as a carrier wave. When the RFID reader 40 receives this signal, it combines the signal and transmits the signal to an external device. As described above, the RFID tag 1 of the present embodiment is a passive radio wave-type wireless tag that does not have a power source (battery) for retaining and transmitting identification information. Therefore, as compared with an active wireless tag that has a battery, it is possible to realize size reduction and cost reduction as much as there is no battery.

For example, as shown in FIG. 2, the loop-shaped conductor 22 is disposed substantially in the center of the inlay 2. The IC chip 21 is superposed on the loop-shaped conductor 22 and electrically connected to the loop-shaped conductor 22. In the present embodiment, the loop-shaped conductor 22 has a position for connection with the IC chip 21 at a position that is substantially in the center of one longer side 222A in the X direction.

The pair of rectangular conductors 23A and 23B extend from the pair of shorter sides 221A and 221B of the loop-shaped conductor 22 to both sides in the longer direction (X direction) of the tag and are formed in a rectangular shape. The “rectangular shape” used in the present embodiment includes an approximately or substantially rectangular shape and encompasses a case where the lengths of two adjacent sides are slightly different or a case where adjacent corners are not exactly right angles, and the like

Further, each of the pair of rectangular conductors 23A and 23B includes a pair of protrusions 231 protruding to the outer side, in the shorter direction, of both ends of the loop-shaped conductor 22 in the shorter direction (Y direction) of the tag. One rectangular conductor 23A has a pair of protrusions 231A and 231B, and one protrusion 231A protrudes to the positive Y direction side and the other protrusion 231B protrudes to the negative Y direction side. The other rectangular conductor 23B has a pair of protrusions 231C and 231D, and one protrusion 231C protrudes to the positive Y direction side and the other protrusion 231D protrudes to the negative Y direction side. In the example shown in FIG. 2, the outer edge of each protrusion 231 in the X direction is positioned to be at the same position as the outer edge of the rectangular conductors 23 in the X direction. In FIG. 2, for the sake of description, the boundary lines, on the Y-direction center side (on a second imaginary line VS side), of the pair of protrusions 231A and 231B of one rectangular conductor 23A and the boundary lines, on the Y-direction center side, of the pair of protrusions 231C and 231D of the other rectangular conductor 23B are shown by dotted lines. However, actually, the protrusions 231A to 231D are formed integrally with the rectangular conductors 23A and 23B.

Further, the pair of rectangular conductors 23A and 23B include strips 232 that protrude from the protrusions 231 toward the center of the tag in the longer direction (X direction) along the longer direction, and are formed in a strip shape. Strips 232A and 232B of one rectangular conductor 23A are formed to protrude along the X direction from the pair of protrusions 231A and 231B to the positive X direction side. Strips 232C and 232D of the other rectangular conductor 23B are formed to protrude along the X direction from the pair of protrusions 231C and 231D to the negative X direction side. In the example of FIG. 2, the outer edge of each strip 232 in the Y direction is positioned so as to be at the same position as the outer edge of the protrusions 231 in the Y direction. In FIG. 2, for the sake of description, the boundary lines between starting ends, on the negative X direction side, of the pair of strips 232A and 232B of one rectangular conductor 23A and the protrusions 231A and 231B, and the boundary lines between starting ends, on the positive X direction side, of the pair of strips 232C and 232D of the other rectangular conductor 23B and the protrusions 231C and 231D are shown by dotted lines. However, in actuality, the strips 232A to 232D are formed integrally with the rectangular conductors 23A and 23B.

In other words, the strips 232 include a pair of strips 232A and 232C provided so as to protrude from the protrusions 231A and 2310 of the pair of rectangular conductors 23A and 23B on one longer side 222A of the pair of longer sides 222A and 222B of the loop-shaped conductor 22. Similarly, on the other longer side 222B, there are a pair of strips 232B and 232D provided so as to protrude from the protrusions 231B and 231D of the pair of rectangular conductors 23A and 23B.

As shown in FIG. 2, it is preferable that each strip 232 is formed so as not to overlap a portion of the loop-shaped conductor 22 on which the IC chip 21 is installed when viewed in the shorter direction (Y direction) of the tag. Thus, since there is no conductor pattern on the outer side of the IC chip 21 in the Y direction, it is considered possible to improve that the wireless transmission performance of the IC chip 21, especially in the Y direction, and it is possible to better inhibit deterioration in the communication performance due to the effect of moisture contained in a pasting target, the effect of close positioning of RFID tags pasted on a plurality of pasting targets, respectively, and the like.

The width (dimension in the Y direction) of each strip 232 is formed to be smaller than the amount of protrusion of each protrusion 231 from the rectangular conductors 23 in the Y direction. Thus, a gap is formed between each strip 232 and the rectangular conductors 23 or the loop-shaped conductor 22.

The pair of rectangular conductors 23A and 23B function as a dipole antennas configured to exhibit resonance with the IC chip 21 in response to the frequencies of radio waves for wireless communication (for example, frequencies in the UHF band) . The rectangular conductors 23A and 23B as a dipole antenna have an electric length corresponding to approximately λ/2 as a whole (where λ is the communication wavelength). The pair of rectangular conductors 23A and 23B have a structure for realizing impedance conjugate matching with the IC chip 21 in response to radio waves having a frequency of, for example, approximately 920 MHz (for example, 860 MHz to 960 MHz, more preferably 915 MHz to 935 MHz).

The conductive wiring pattern of the inlay 2 including the loop-shaped conductor 22 and the rectangular conductors 23 can be formed by existing methods such as pressing or etching of a copper foil or an aluminum foil, a formation method by plating, silkscreen printing of a metal paste, a metal wire, and the like. Here, the conductive wiring pattern is formed by etching of aluminum.

As shown in FIG. 2, it is preferable that the conductive wiring pattern of the inlay 2 including the loop-shaped conductor 22 and the rectangular conductors 23 is formed in line symmetry with respect to a first imaginary line VL passing through substantially the longer-direction center of the RFID tag 1 in a plan view (the center being the position where the IC chip 21 is situated in FIG. 2). The first imaginary line VL is a line parallel with the XY plane and extending in the Y direction. The first imaginary line VL is also a line substantially bisecting the RFID tag 1 into regions in the X direction. In FIG. 2, the first imaginary line VL is indicated by a dot-and-dash line extending in the Y direction.

Similarly, as shown in FIG. 2, it is preferable that the conductive wiring pattern of the inlay 2 including the loop-shaped conductor 22 and the rectangular conductors 23 is formed in line symmetry with respect to the second imaginary line VS passing through substantially the shorter-direction center of the RFID tag 1 in a plan view. The second imaginary line VS is a line parallel with the XY plane and extending in the X direction. The second imaginary line VS is also a line substantially bisecting the RFID tag 1 into regions in the Y direction. In FIG. 2, the second imaginary line VS is indicated by a dot-and-dash line extending in the X direction.

That is, in the present embodiment, the conductive wiring pattern of the inlay 2 including the loop-shaped conductor 22 and the rectangular conductors 23 is formed so as to be in line symmetry with respect to both of the X and Y directions.

As shown in FIG. 2, it is preferable that the pair of rectangular conductors 23A and 23B are formed so as to project in the X direction from the entirety of the pair of shorter sides 221A and 221B in their extending direction (Y direction). That is, it is preferable that the shorter side 221A and the rectangular conductor 23A on the left side in FIG. 2 are formed integrally, and it is preferable that the shorter side 221B and the rectangular conductor 23B on the right side in FIG. 2 are formed integrally.

In FIG. 2, for the sake of description, the boundary line between one rectangular conductor 23A and one shorter side 221A and the boundary line between the other rectangular conductor 23B and the other shorter side 221B are indicated by dotted lines, but in actuality, the pair of rectangular conductors 23A and 23B are formed integrally with the loop-shaped conductor 22. That is, the boundary lines between the pair of rectangular conductors 23A and 23B and the pair of shorter sides 221A and 221B, the boundary lines between the pair of rectangular conductors 23A and 23B and the four protrusions 231A to 231D, and the boundary lines between the four protrusions 231A to 231D and the four strips 232A to 232D, which are indicated by dotted lines in FIG. 2, are not actually formed on the conductor pattern of the inlay 2.

The pair of rectangular conductors 23A and 23B need only to be formed so as to project in the X direction from the pair of shorter sides 221A and 221B. They may be formed so as to project in the X direction from only a portion of the pair of shorter sides 221A and 221B in the extending direction (Y direction).

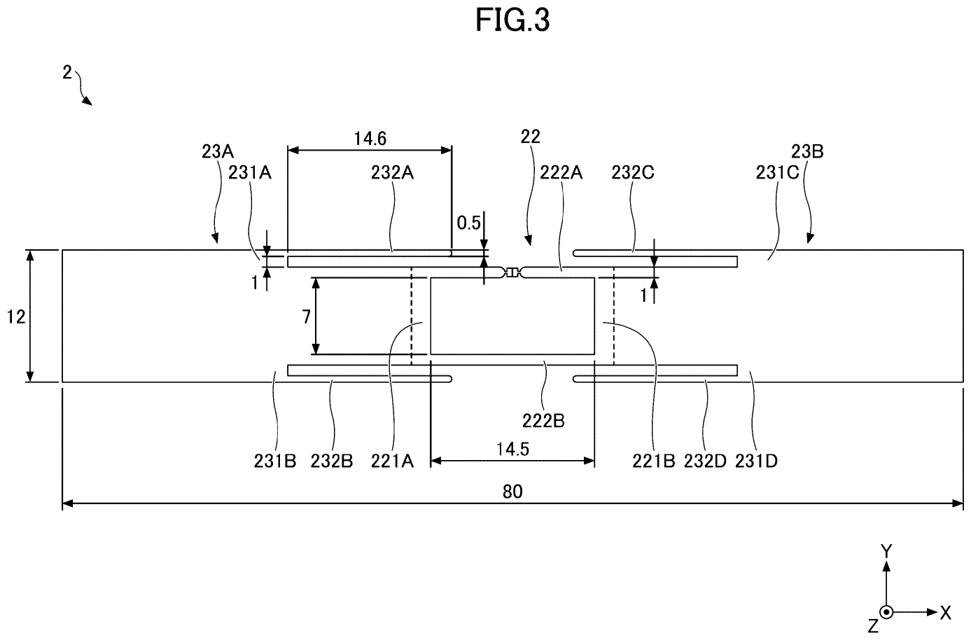

FIG. 3 is a diagram showing an example of the dimensions of each part of the conductor pattern of the inlay 2 shown in FIG. 2. In the example of dimensions shown in FIG. 3, all of the conditions related to the shapes of the loop-shaped conductor 22 and the rectangular conductors 23 described above are satisfied.

Owing to the configuration including the loop-shaped conductor 22 and the rectangular conductors 23 that are formed in the conductive pattern shown in FIG. 2 as described above, it is possible to inhibit deterioration in the communication performance of the RFID tag 1 according to the present embodiment due to the effect of moisture contained in the pasting target and the effect of close positioning of RFID tags pasted on a plurality of pasting targets.

In the present embodiment, for the sake of description, the loop-shaped conductor 22 and the rectangular conductors 23 are used as separate elements, and FIG. 2 shows them separately by dotted lines. However, in the present embodiment, the loop-shaped conductor 22 and the rectangular conductors 23 are actually formed integrally as described above, and the separation positions between the loop-shaped conductor 22 and the rectangular conductors 23 shown by dotted lines in FIG. 2 are merely examples. That is, in the present embodiment, there may be a case where not only the rectangular conductors 23 but also at least a part of the loop-shaped conductor 22 function as an antenna. Similarly, there may be a case where at least a part of the rectangular conductors 23 also functions as the loop-shaped conductor.

As shown in FIG. 1, in the RFID tag 1 of the present embodiment, a label paper (film-based tack paper) 3 is further disposed above the inlay 2. Print can be applied to a surface of the label paper 3 on the positive side on the Z-axis. The material of the label paper 3 can be appropriately selected, and a material other than paper, such as a resin material, may be used as long as print can be applied to the material.

The dimension of the label paper 3 in the X-direction is larger than that of the inlay 2, and the inlay 2 is situated in the center of the dimension and surplus parts that do not overlap the inlay 2 are situated on both sides in the X-direction. On the back side of the surplus parts that are on the negative side on the Z-axis, adhesive parts 4 having adhesiveness on their surface (lower surface in FIG. 1) to be in contact with the pasting target are provided. Thus, the inlay 2 and the adhesive parts 4 are situated so as not to overlap when viewed in a plan view. In the example of FIG. 1, a pair of adhesive parts 4A and 4B are situated on the positive side and the negative side of the inlay 2 on the X-axis.

The adhesive parts 4 come into contact with the pasting target and adhere to the pasting target by their adhesive force, whereby the entirety of the RFID tag 1 is pasted on the pasting target.

It is preferable that the adhesive parts 4 are formed of, for example, an adhesive type hot melt. The hot melt is a thermoplastic adhesive that is solid at normal temperature, but liquefies through heating and melting and is applied to the adhesion target to form junction through cooling and solidification. The adhesive type hot melt has a property of having an adhesive force on an exposed surface thereof even after cooling and solidifying. It is preferable that the adhesive parts 4 are formed of a material (biomass) of a biological origin or a biodegradable material. The biomass content in the adhesive parts 4 is, for example, 25%.

A joining part 5 is laminated on the back surface of the label paper 3 on the negative side on the Z-axis. The joining part 5 is joined to the upper surface of the inlay 2 and to the upper surface of the adhesive parts 4, whereby the inlay 2 and the adhesive parts 4 are covered with the label paper 3. In addition, during lamination, the joining part 5 can enter a gap formed by the inlay 2 and the upper label paper 3 and fill the gap.

It is preferable that the joining part 5 is formed of, for example, a non-adhesive hot melt. The non-adhesive hot melt has no adhesive force on an exposed surface thereof after cooling and solidification. Like the adhesive parts 4, it is preferable that the joining part 5 is formed of a material (biomass) of a biological origin or a biodegradable material.

A release paper 6 is provided under the adhesive parts 4 of the RFID tag 1 before use. The release paper 6 is formed, for example, with a size equal to or larger than that of the label paper 3, and the label paper 3 and the release paper 6 are brought into close adhesion with each other by the adhesive parts 4. Thus, the pair of the adhesive parts 4A and 4B on both sides of the label paper 3 in the X direction are prevented from being exposed to the outside before being used for pasting of the pasting target, and the adhesive force can be maintained. When using the RFID tag 1, the release paper 6 is peeled off from the RFID tag 1, and the RFID tag 1 is pasted on the pasting object by the exposed adhesive parts 4A and 4B of the label paper 3.

Further, the release paper 6 may be larger than that illustrated in FIG. 1, and a plurality of RFID tags 1 may be arranged on one release paper 6. This can improve the manufacturing efficiency and the transportation efficiency.

The thickness of the RFID tag 1 in the Z direction (excluding the release paper 6) according to this embodiment is 80 μm to 260 μm, preferably 150 μm to 230 μm. The thickness of the adhesive parts 4 in the Z direction is preferably approximately 10 μm to 30 μm.

In the RFID tag 1 according to this embodiment, the inlay 2 and the adhesive parts 4 are arranged so as not to overlap when viewed in a plan view as described above, and in the example of FIGS. 1 and 2, the pair of adhesive parts 4A and 4B are arranged on the positive direction side and the negative direction side of the inlay 2 on the X-axis. With this configuration, the inlay 2 itself is not directly pasted on the pasting target, but indirectly pasted on the pasting target via the adhesive parts 4.

The lamination structure of the RFID tag 101 is not limited to that shown in FIG. 1. For example, the label paper 3 may be formed with the same size as the inlay 2. In this case, since the outer edge of the label paper 3 cannot contact the pasting target, the adhesive parts 4 are provided on the entire lower surface of the base member 24 of the inlay 2 facing the pasting target, and the inlay 2 is directly pasted on the pasting target. In the structure shown in FIG. 1, an adhesive part may also be continuously provided between the pair of adhesive parts 4A and 4B to form a single adhesive layer. In this case, the inlay 2 is also directly pasted on the pasting target.

The RFID tag 1 may also have a structure in which elements such as a magnetic sheet, a spacer layer, and a dielectric layer are further laminated on the pasting target side (lower side in FIG. 1) of the inlay 2. The magnetic sheet is a sheet material containing a magnetic material, it is preferable to use a magnetic sheet having excellent magnetic shielding characteristics against radio waves in a frequency band (e.g., UHF band) used for reading the IC chip 21. The spacer layer is an element for positioning the inlay 2 so as to be separated from the pasting target by the thickness thereof, and it is preferable that the spacer layer is formed of an insulator such cardboard, woven fabric or nonwoven fabric made of fibers of synthetic resins and the like, a sheet of an inorganic material such as ceramic glass, and the like. It is preferable that the dielectric layer is formed of an insulator material having a relative permittivity of approximately 1.2 to 3.0, thereby increasing the communication distance of the RFID tag 1.

### Application Example of RFID Tag 1

FIG. 4 is a diagram showing an example of a configuration in which the RFID tag 1 according to the embodiment is pasted on a book 30 as the pasting target. As shown in FIG. 4, when the pasting target is a book 30, the RFID tag 1 can be pasted on, for example, a back surface 31A of a back cover 31. When the pasting target is the book 30, for example, various bibliographic information about the book 30 on which the tag is pasted can be recorded in the IC chip 21 of the RFID tag 1.

When the pasting target is the book 30, the pasting position of the RFID tag 1 is not limited to the example of FIG. 4, but may be other positions, such as, for example, a front surface 31B of the back cover 31, a back surface 32A or a back surface 32B of a front cover 32, a spine 33, an endleaf 34, a title page 35, and the like. In order to read information from the RFID tag 1 with high accuracy, it is preferable that the pasting position of the RFID tag 1 is as close as possible to an outer surface of the book 30 so as to minimize the number of shielding objects between the tag and a reading device such as the RFID reader 40 (see FIG. 5).

FIG. 5 is a diagram showing an example of a method for reading information from RFID tags 1-1 to 1-5 pasted on a plurality of books 30-1 to 30-5 as the pasting targets. As shown in FIG. 5, a case is considered in which RFID tags 1-1 to 1-5 are pasted on a plurality of books 30-1 to 30-5, respectively, and the plurality of books 30-1 to 30-5 are stacked vertically and laid on their side.

In this case, using a small-sized, lightweight, and portable reading device such as the RFID reader 40 shown in FIG. 5, a user approaches the books 30-1 to 30-5 laid on their side and operates the RFID reader 40. As a result, information ID1 to ID5 related to the books 30-1 to 30-5 recorded in the RFID tags 1-1 to 1-5 can be collectively read from the RFID tags 1-1 to 1-5 pasted on the books 30-1 to 30-5.

The reading device may be a stationary type and the books 30-1 to 30-5 laid on their side may be placed in the reading range of the reading device, and the information ID1 to ID5 may be read from the RFID tags 1-1 to 1-5. Also, when the plurality of books 30-1 to 30-5 are arranged side by side closely to each other on a bookshelf, that is, when the plurality of books are stacked in the horizontal direction, the information ID1 to ID5 can be collectively read from the RFID tags 1-1 to 1-5 in the same manner as described above.

The books 30 are made by binding multiple sheets of paper. As shown in FIG. 5, it is often the case that many books 30-1 to 30-5 are laid on their side when they are sold or stored at a bookstore, or stored in a library. Therefore, for example, when the RFID tag 1 is pasted on a cover portion such as the front cover 32 or the back cover 31, or on the endleaf 34 or the title page 35 close to the cover portion, the RFID tags 1-1 to 1-5 of the books 30-1 to 30-5 laid on their side may be in a position to be sandwiched between the upper and lower books. Therefore, conventionally, due to the effect of the close positioning of the RFID tags pasted on the books 30-1 to 30-5 or the effect of moisture contained in the multiple sheets of paper forming the books 30-1 to 30-5, the communication distance of the RFID tags may be shortened, and the RFID tag reading accuracy may be deteriorated. The same problem may occur when the plurality of books 30 are arranged side by side closely to each other on a bookshelf.

On the other hand, as described above, owing to the configuration including the loop-shaped conductor 22 and the rectangular conductors 23 formed by the conductor pattern shown in FIG. 2, the RFID tag 1 of the present embodiment can inhibit deterioration in the communication performance due to the effect of moisture contained in the pasting target (for example, the book 30) or the effect of close positioning of the RFID tags 1-1 to 1-5 pasted on the plurality of pasting targets (for example, the books 30-1 to 30-5). Therefore, when the RFID tag 1 of the present embodiment is applied to a pasting target formed by stacking multiple sheets of paper, such as the book 30 in particular, the effect of inhibiting deterioration in the communication performance can be more remarkably exhibited. Furthermore, since the same effect can be obtained when a plurality of books 30-1 to 30-5 are stacked, it is possible to read the information ID1-ID5 from the tags 1-1 to 1-5 with high accuracy.

### Modified Examples

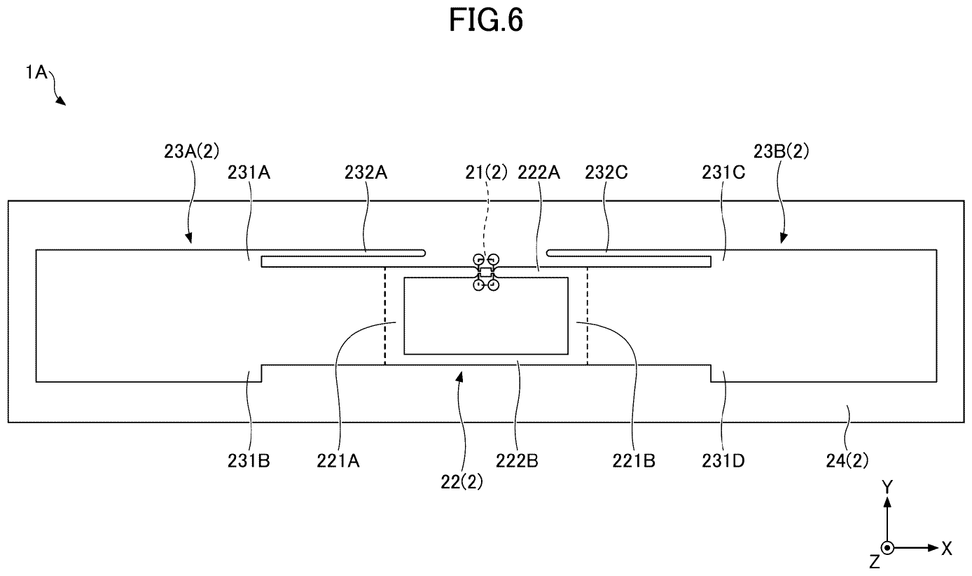

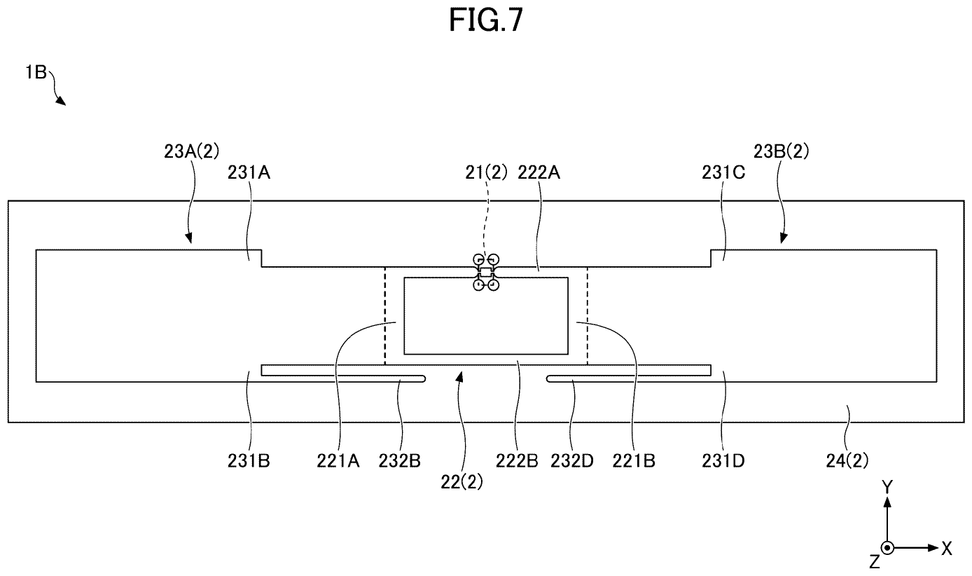

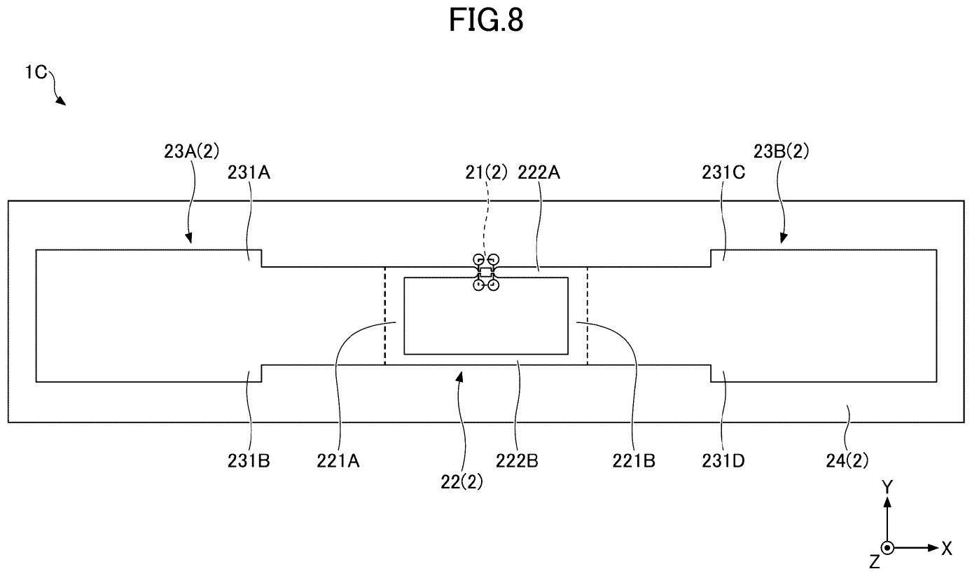

FIG. 6 is a plan view of an RFID tag 1A according to a first modified example. FIG. 7 is a plan view of an RFID tag 1B according to a second modified example. FIG. 8 is a plan view of an RFID tag 1C according to a third modified example. FIGS. 6 to 8 correspond to FIG. 2, and show only the elements related to the inlays 2 of the respective RFID tags 1A to IC similarly in FIG. 2.

In the above embodiment, a configuration has been exemplified in which the conductor pattern of the inlay 2 includes the four strips 232A, 232B, 232 C, and 232D, but at least a part of the strips 232 does not need to be provided.

For example, as in the RFID tag 1A of the first modified example shown in FIG. 6, the strips 232 may include only the pair of strips 232A and 232C provided so as to protrude from the protrusions 231A and 231C of the pair of rectangular conductors 23A and 23B on one longer side 222A of the pair of longer sides 222A and 222B of the loop-shaped conductor 22, and the remaining strips 232B and 232D do not need to be provided. In other words, the conductor pattern of the inlay 2 may have a configuration in which the pair of rectangular conductors 23A and 23B do not include the two strips 232B and 232D of the four strips 232A to 232D.

Further, as in the RFID tag 1B of the second modified example shown in FIG. 7, the strips 232 may include only the pair of strips 232B and 232D provided so as to protrude from the protrusions 231B and 231D of the pair of rectangular conductors 23A and 23B on the other longer side 222B of the pair of longer sides 222A and 222B of the loop-shaped conductor 22, and the remaining strips 232A and 232C do not need to be provided. In other words, the conductor pattern of the inlay 2 may have a configuration in which the pair of rectangular conductors 23A and 23B do not include the two strips 232A and 232C of the four strips 232A to 232D.

Moreover, a configuration including only two strips as in the first modified example and the second modified example, but including one strip on the positive Y direction side and one strip on the negative Y direction side unlike in the first modified example and the second modified example is also possible. For example, a configuration including the strip 232A on the upper left of the drawing and the strip 232D on the lower right of the drawing, a configuration including the strip 232B on the lower left of the drawing and the strip 232C on the upper right of the drawing, a configuration including the strip 232A on the upper left of the drawing and the strip 232B on the lower left of the drawing, and a configuration including the strip 232C on the upper right of the drawing and the strip 232D on the lower right of the drawing are possible. Further, a configuration free of any one selected from the strips 232A to 232D and including the remaining three strips, and a configuration including only one of the strips 232A to 232D are also possible.

A configuration that is free of at least one of such protrusions that are not provided with strips is also possible. For example, in the first modified example shown in FIG. 6, the conductor pattern of the inlay 2 does not need to include at least one of the two protrusions 231B and 231D that are not provided with strips 232B and 232D. Similarly, in the first modified example shown in FIG. 7, the conductor pattern of the inlay 2 does not need to include at least one of the two protrusions 231A and 231C that are not provided with strips 232A and 232C.

Further, as in the RFID tag 1C of the third modified example shown in FIG. 8, none of the four strips 232A, 232B, 232C, and 232D may be provided. In this case, at least one of the four protrusions 231A, 231B, 231C, and 231D does not need to be provided. In other words, the conductor pattern of the inlay 2 may have a configuration in which the pair of rectangular conductors 23A and 23B do not include four strips 232A to 232D, or the pair of rectangular conductors 23A and 23B do not include at least one of the four protrusions 231A to 231D.

For example, the conductor pattern shown in FIG. 8, may have a configuration in which the four protrusions 231A, 231B, 231C, and 231D indicated by dotted lines in FIG. 2 are not be provided. In this case, the pair of rectangular conductors 23A and 23B have a shape in which the length of the shorter sides is the same as the length of the shorter sides 221A and 221B of the loop-shaped conductor 22, and the positions of the longer sides in the Y direction are the same as the outer edges of the longer sides 222A and 222B of the loop-shaped conductor 22.

Similarly to the RFID tag 1 of the embodiment, owing to the configuration including the loop-shaped conductor 22 and the rectangular conductors 23 formed by the conductor patterns shown in FIGS. 6, 7, 8, and the like, the RFID tags 1A, 1B, and 1C according to these modified examples can inhibit deterioration in the communication performance due to the effect of moisture contained in the pasting target, the effect of close positioning of RFID tags pasted on a plurality of pasting targets, and the like.

### EXAMPLES

Next, Examples of the present invention will be specifically described.

### Setting of First Test

Examples 1 to 3 and Comparative Examples 1 to 3 were set as described below, and a first test was conducted to verify the effect on the performance quality of RFID tags depending on the conductor pattern of the inlay 2.

### Example 1

The RFID tag 1 shown in FIGS. 1 and 2 was manufactured to have the dimensions of each part shown in FIG. 3. The manufactured RFID tag 1 was pasted on a sheet of duodecimo coated paper having weight of 110 kg (108.00 mm×151.00 mm). The pasting position was a position at which a longer side and a shorter side of the tag 1 were at a distance of 13.00 mm from the outer edges of the lower right part of the sheet viewed in a plan view while being placed to have its longer direction extend in the vertical direction.

As the book 30 that was the pasting target, a comic book of a paperback pocket edition (113 mm in width×176 mm in height) was selected. The paper on which the RFID tag 1 was pasted was inserted between the back cover 31 and the last page of the book such that the surface on which the tag was pasted would face the last page side, to bring about the same state as a state in which the tag was pasted on the back surface 31A of the back cover 31.

Using the book 30 on which the RFID tag 1 was pasted, the reading performance of the RFID tag 1 was tested in accordance with a guideline for measuring and evaluating the performance quality of RFID tags, referred to as Tagged-Item Performance Protocol (TIPP) Tagged Item Grading (https://www.gs1.org/sites/default/files/docs/epc/Tagge d_Item_Test_Methodology.pdf). This guideline was standardized by an international organization named GS1.

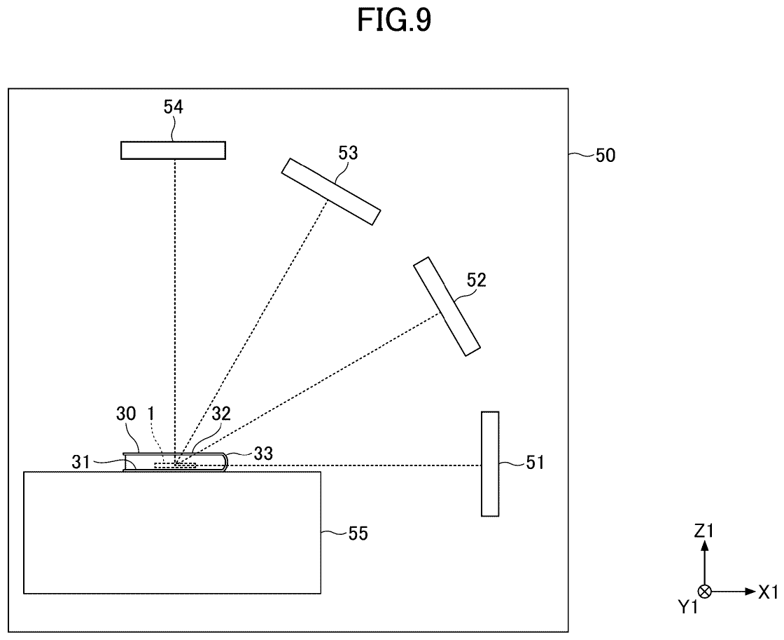

FIG. 9 is a schematic diagram of the measurement environment of the first test according to Example 1. As shown in FIG. 9, four RFID antennas including a first antenna 51, a second antenna 52, a third antenna 53, and a fourth antenna 54 were installed in the anechoic chamber 50. The measurement environment shown in FIG. 9 is based on the provisions of the above guideline. C50 was applied to the anechoic chamber 50. Tagformance Pro obtained from Voyantic Ltd. was used as the measuring instrument including the first to fourth antennas 51 to 54.

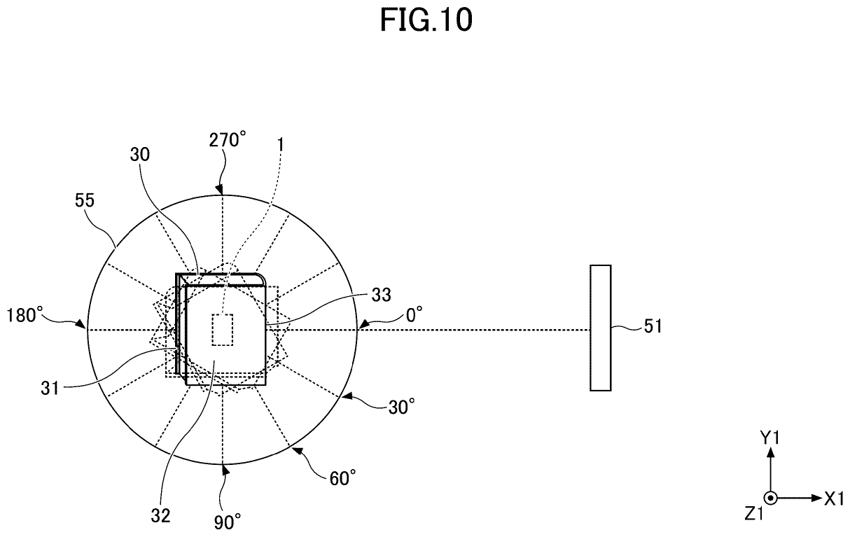

In the following description, an X1 direction, a Y1 direction, and a Z1 direction orthogonal to each other are set. The Z1 direction is the vertical direction of the anechoic chamber 50. The X1 direction and the Y1 direction are horizontal directions of the anechoic chamber 50, and are 0-degree and 270-degree directions of a mounting table 55, respectively (see FIG. 10). For the sake of description, the positive side on the Z1 axis may be referred to as the upper side, and the negative side on the Z axis may be referred to as the lower side.

As shown in FIG. 9, the first antenna 51, the second antenna 52, the third antenna 53, and the fourth antenna 54 are situated so as to face a predetermined one point in the anechoic chamber 50, and as indicated by dotted lines in FIG. 9, are situated at positions at which they face the predetermined point in directions that are at angles of 0 degrees, 30 degrees, 60 degrees, and 90 degrees from a horizontal direction, respectively. The first to fourth antennas 51 to 54 are situated along the same X1Z1 plane.

One book 30 on which the RFID tag 1 was pasted was prepared and placed on the upper surface of the mounting table 55 in the anechoic chamber 50. The book 30 was placed such that the front cover 32 was on the upper side and the back cover 31 was on the lower side, that is, the RFID tag 1 was placed on the lower end side of the book 30. Therefore, the book 30 was placed in a state in which the number of books to be placed in a stack while on their side was one, so the pages of one book 30 were stacked above the RFID tag 1. As shown by dotted lines in FIG. 9, the height of the mounting table 55 was adjusted such that the RFID tag 1 was placed at the predetermined point at which the facing directions of the first to fourth antennas 51 to 54 intersect each other. All of the first to fourth antennas 51 to 54 were installed such that their distance from the RFID tag 1 that was at the predetermined point would be 1 m.

FIG. 10 is a plan view of the measurement environment shown in FIG. 9. In FIG. 10, only the first antenna 51 that was situated in a horizontal direction among the first to fourth antennas 51 to 54 is shown for convenience of illustration, but the relationship between the other second, third, and fourth antennas 52, 53, and 54 and the orientations of the RFID tag 1 and the book 30 is similar as well. As shown in FIG. 10, a state of the book 30 being placed on the mounting table 55 in an orientation in which the spine 33 would normally face the first to fourth antennas 51 to 54 is defined as the 0-degree direction of the book, and each rotation of the orientation of the spine 33 in the clockwise direction in FIG. 10 about the predetermined point at which the RFID tag 1 is placed increases the angle. The mounting table 55 can rotate about a rotation axis along the Z direction passing through the aforementioned predetermined point, and it is possible to change the orientation of the spine 33 of the book 30 placed on the mounting table 55 by rotating the mounting table 55.

Under these conditions, the sensitivity (average output for reading information from the RFID tag 1) of the first to fourth antennas 51 to 54 was measured with the spine 33 of the book 30 oriented in ten directions including the 0-degree direction, a 30-degree direction, a 60-degree direction, a 120-degree direction, a 150-degree direction, a 180-degree direction, a 210-degree direction, a 240-degree direction, a 300-degree direction, and a 330-degree direction. In addition, the backscatter (the intensity of a response wave from the RFID tag 1) of the first to fourth antennas 51 to 54 was measured in two directions, namely the 0-degree direction and the 180-degree direction.

Using each of the above measured values, it was determined whether or not a condition of a grade that was set in the TIPP was satisfied. The grade is an evaluation criterion relating to the quality of the reading performance of the RFID tag 1, and a plurality of types of grades are set. At each grade, a reference value is set per value to be measured as described above. Different values are set for different grades. When all measured values exceed their reference values, it is possible to evaluate that the condition of the corresponding grade is satisfied. A grade, of which the condition could be satisfied when one book 30 was laid on its side as in the present Example 1, was investigated.

### Example 2

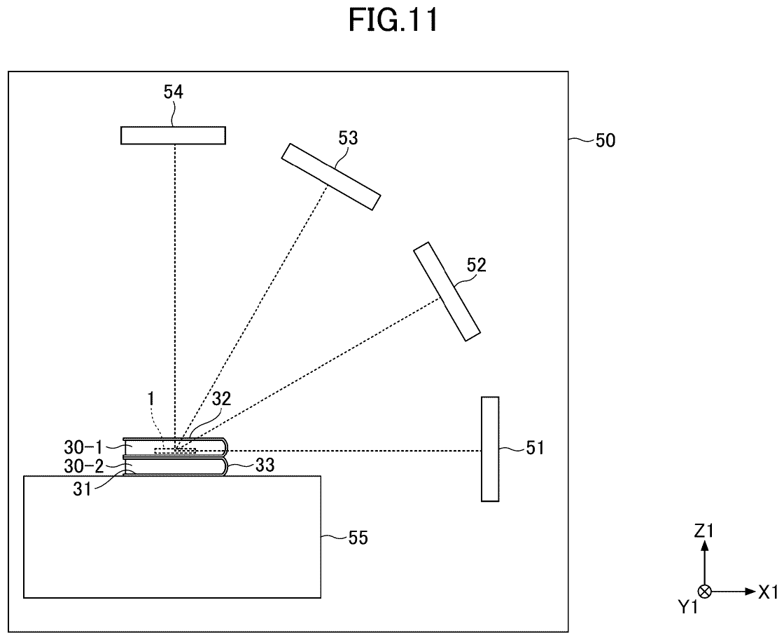

FIG. 11 is a schematic view of the measurement environment of the first test according to Example 2. As shown in FIG. 11, in Example 2, the measurement was performed under the same conditions as in Example 1 except that the number of books to be placed in a stack while on their side was two. The plan view of the test environment is the same as that in Example 1 shown in FIG. 10.

When the number of stacked books was two, a book 30-1 on which the RFID tag 1 was pasted was stacked on the upper side with its back cover 31 coming to the lower side. In other words, the pages of the one book 30-1 were stacked above the RFID tag 1, and the pages of the lower one book 30-2 were stacked under the RFID tag 1. Further, as indicated by the dotted lines in FIG. 11, the height of the mounting table 55 was adjusted such that the RFID tag 1 pasted on the upper book 30-1 was placed at a predetermined point at which the facing directions of the first to fourth antennas 51 to 54 intersect each other.

Using each measured value obtained by performing the same measurement as in Example 1, a grade, of which the condition could be satisfied when two books 30 were laid on their side as in the present Example 2, was investigated.

### Example 3

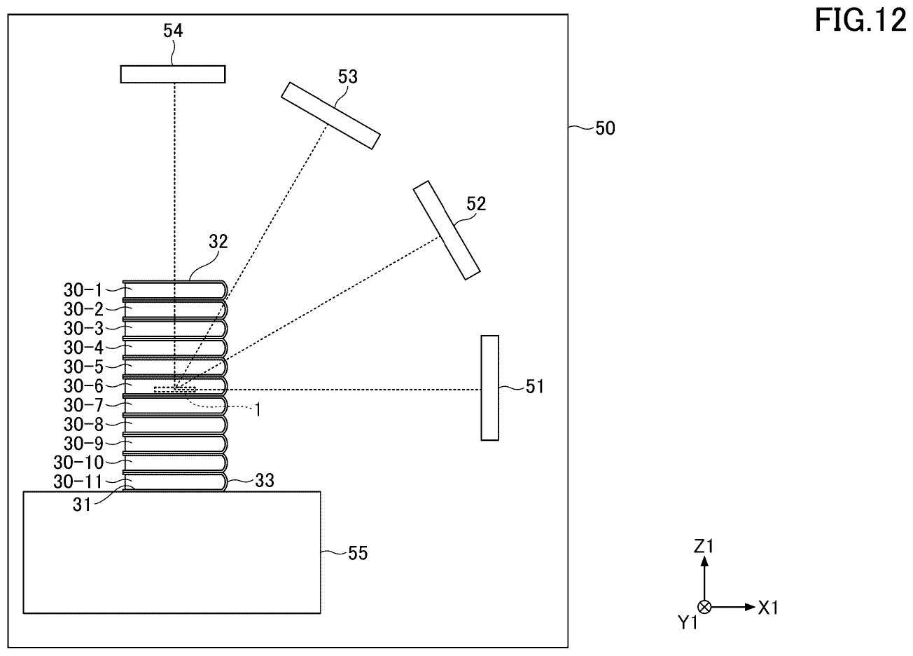

FIG. 12 is a schematic diagram of the measurement environment of the first test according to Example 3. As shown in FIG. 12, in Example 3, measurement was performed under the same condition as in Example 1 except that the number of books to be placed in a stack while on their side was eleven. The plan view of the test environment is the same as that of Example 1 shown in FIG. 10.

When the number of books placed in a stack was eleven, a book with the RFID tag 1 was the book placed in the center in the stacking direction, that is, a book 30-6 stacked in the sixth order from the top and the sixth order from the bottom, and it was stacked with its back cover 31 coming to the lower side. That is, the pages of six books, i.e., six books 30-1 to 30-6 including the book 30-6 were stacked above the RFID tag 1, and the pages of five books, i.e., five books 30-7 to 30-11 that were to be lower than the book were stacked under the RFID tag 1. The height of the mounting table 55 was adjusted such that the RFID tag 1 pasted on the book 30-6 that was in the center in the stacking direction was placed at a predetermined point at which the facing directions of the first to fourth antennas 51 to 54 intersect each other, as indicated by dotted lines in FIG. 12.

Using each measured value obtained by performing the same measurement as in Example 1, a grade, of which the condition could be satisfied when eleven books 30 were laid on their side as in the present Example 3, was investigated.

### Comparative Example 1

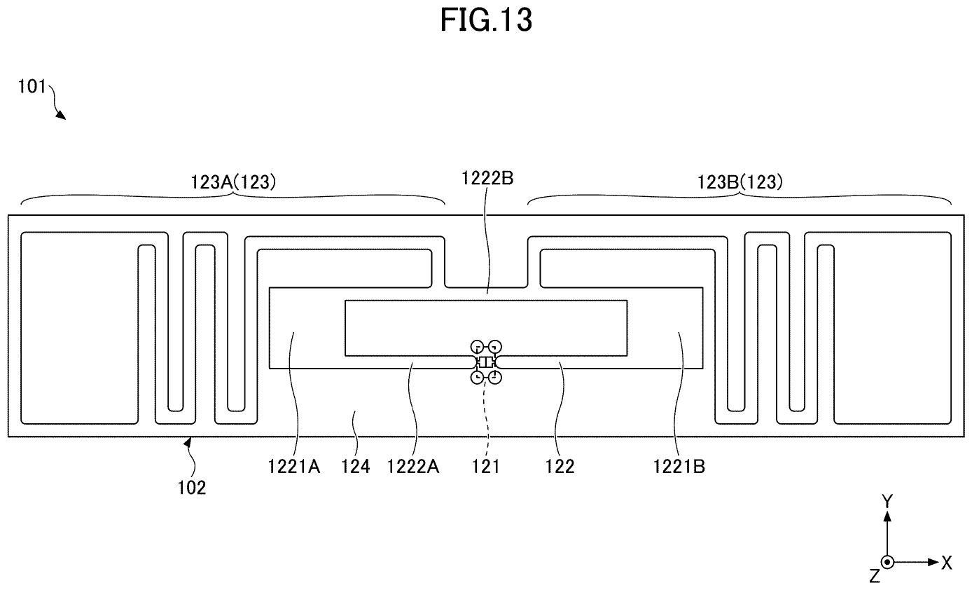

FIG. 13 is a plan view showing a conductor pattern of an RFID tag 101 used in Comparative Examples 1 to 3. FIG. 13 corresponds to FIG. 2, and like FIG. 2, only the elements related to the inlay of the RFID tag 101 are shown. In Comparative Example 1, the measurement was performed under the same conditions as in Example 1 except that the RFID tag 101 having the existing conductor pattern shown in FIG. 13 was used as the tag to be pasted on the book 30.

As shown in FIG. 13, the RFID tag 101 according to Comparative Examples 1 to 3 has an inlay including an IC chip 121, a loop-shaped conductor 122, and an antenna part 123. The inlay includes the loop-shaped conductor 122 and the antenna part 123 that are formed by pasting an aluminum sheet by dry laminate on a base member made of a synthetic resin film such as polyethylene terephthalate, polypropylene, or the like, and the IC chip 121 is mounted at a predetermined position of the inlay.

Since the IC chip 121 is the same as the IC chip 21 of the embodiment shown in FIGS. 1 and 2 and the like, the description thereof will be omitted. The shape and function of the loop-shaped conductor 122 are also the same as those of the loop-shaped conductor 22 of the embodiment, and have a pair of shorter sides 1221A and 1221B extending in the shorter direction of the RFID tag 101 and a pair of longer sides 1222A and 1222B extending in the longer direction. The loop-shaped conductor 122 is electrically connected to the IC chip 121 and the antenna part 123.

The antenna part 123 has a structure for realizing impedance conjugate matching with the IC chip 121 with respect to a radio wave having a frequency around, for example, 920 MHz (for example, 860 MHz to 960 MHz, more preferably 915 MHz to 935 MHz). The antenna part 123 has two conductor parts (a conductor part 123A and a conductor part 123B) as the structure for realizing impedance conjugate matching with the IC chip 121. The conductor part 123A and the conductor part 123B are conductive wiring patterns that are connected to the loop-shaped conductor 122 and extend in directions to be apart from each other, starting from the loop-shaped conductor 122 (to the positive direction side and the negative direction side on the X-axis in the example of FIG. 13). The conductive wiring patterns can be formed by existing methods such as pressing or etching of a copper foil or an aluminum foil, a formation method by plating, silkscreen printing of a metal paste, a metal wire, and the like. Here, the conductive wiring patterns ae formed by etching of aluminum.

The conductor part 123A and the conductor part 123B are formed in line symmetry with respect to an imaginary line passing through substantially the center of the IC chip 121 (the imaginary line corresponding to the first imaginary line VL in FIG. 2). The imaginary line is a line parallel with the XY plane and extending in the Y direction. The imaginary line is also a line substantially bisecting the RFID tag 101 into regions in the X direction.

As shown in FIG. 13, the RFID tag 101 according to Comparative Examples 1 to 3 is different from the RFID tag 1 according to the above-described embodiment in that the pair of conductor parts 123A and 123B of the antenna part 123 are both connected to one longer side 1222B of the loop-shaped conductor 122 on the positive Y direction side, the conductor parts 123A and 123B are not simply rectangular like the rectangular conductors 23 of the above-described embodiment but have a more complicated shape including wirings extending in a zigzag shape, and the conductor pattern is not formed in line symmetry with respect to the second imaginary line VS (see FIG. 2) that passes through substantially the center of the RFID tag 101 in the shorter direction (Y direction) and extends in the longer direction (X direction) when viewed in a plan view.

Using each measured value obtained by performing the same measurement as in Example 1, it was determined whether or not the condition of a grade set in the TIPP was satisfied. Since Comparative Example 1 is an example in which laying one book 30 on its side was the test environment as in Example 1, a grade, of which the condition could be satisfied when one book 30 was laid on its side as in Example 1, was investigated.

### Comparative Example 2

In Comparative Example 2, the measurement was performed under the same conditions as in Example 2 except that the RFID tag 101 having the existing conductor pattern shown in FIG. 13 was used as the tag to be pasted on the book 30.

Using each measured value obtained by performing the same measurement as in Example 2, it was determined whether or not the condition of a grade set in the TIPP was satisfied. Since Comparative Example 2 is an example in which laying two books 30 on their side was the test environment as in Example 2, a grade, of which the condition could be satisfied when two books 30 were laid on their side as in Example 2, was investigated.

### Comparative Example 3

In Comparative Example 3, the measurement was performed under the same conditions as in Example 3 except that the RFID tag 101 having the existing conductor pattern shown in FIG. 13 was used as the tag to be pasted on the book 30.

Using each measured value obtained by performing the same measurement as in Example 3, it was determined whether or not the condition of a grade set in the TIPP was satisfied. Since Comparative Example 3 is an example in which laying eleven books 30 on their side was the test environment as in Example 3, a grade, of which the condition could be satisfied when eleven books 30 were laid on their side as in Example 3, was investigated.

### Results of the First Test

As a result of the first test described above, it was confirmed that both Comparative Example 1 and Example 1 satisfied the condition of Grade S25A set in the TIPP. It was also confirmed that both Comparative Example 2 and Example 2 satisfied the conditions of Grade M25C and M30E set in the TIPP.

Comparative Example 3 failed to satisfy the conditions of Grade M25C and M30E set in the TIPP. In the case of M25C, eleven out of twenty-four measured values failed to satisfy the reference values. In the case of M30E, twenty one out of twenty-four measured values failed to satisfy the reference value.

Example 3 also failed to satisfy the conditions of Grade M25C and M30E set in the TIPP. However, in M25C, the number of measured values that failed to satisfy the reference values among twenty-four measured values decreased to 1. In M30E, the number of measured values that failed to satisfy the reference values among twenty-four measured values decreased to 10. In other words, under the test condition in which eleven books 30 were laid on their side, it was successfully confirmed that the communication performance in Example 3 improved over Comparative Example 3.

As described above, the results of the first test showed that when the RFID tags were pasted on books 30, the conductor pattern of the RFID tag 1 of the present embodiment was less affected by moisture contained in the pages of the book 30 serving as the pasting target and was able to better inhibit deterioration in the communication performance than was the existing conductor pattern of the RFID tag 101 of Comparative Examples shown in FIG. 13.

### Setting of Second Test

Examples 4 to 7 and Comparative Examples 4 to 5 were set as described below, and a second test was conducted to verify the effect on the communication performance of the RFID tag depending on the conductor pattern of the inlay 2.

### Example 4

In the test environment described with reference to FIG. 9, a reading test for reading information from the RFID tag 1 was performed using only the first antenna 51 situated in a horizontal direction among the four RFID antennas. The direction of the book 30 placed on the mounting table 55 was set to the 0-degree direction described above, such that the spine 33 was made to normally face the first antenna 51.

Under this condition, the frequency characteristics of the RFID tag 1 were measured. The measurement frequency band of the radio waves for wireless communication during the measurement was set to 800 to 1000 MHz, and the Equivalent Isotropically Radiated Power (EIRP) was set to 3.28 W. The measurement of the frequency was performed for the cases in which the number of books 30 to be placed in a stack was one, two, and eleven, that is, in the test environments shown in FIGS. 9, 11, and 12. For reference, the measurement was also performed in a state where only the RFID tag 1 was placed on the mounting table 55 without the RFID tag 1 being pasted on the book 30. In Example 4, unlike Examples 1 to 3, the distance of the first antenna 51 from the position on the mounting table 55 at which the RFID tag 1 was placed was changeable.

### Example 5

In the same test environment as in Example 4, the number of books 30 to be placed in a stack while being mounted on the mounting table 55 was set to eleven, and books on which RFID tags 1 were pasted were used for all of the eleven books. Then, the number of readable tags out of eleven RFID tags 1 pasted on the eleven books was measured. The radio wave intensity during the measurement was set to 0 to 27 (dBm), and the distance from the mounting position of the RFID tags 1 on the mounting table 55 to the first antenna 51 was set to 0.5 m.

### Comparative Example 4

In Comparative Example 4, the measurement was performed under the same condition as in Example 4 except that RFID tags 101 having the existing conductor pattern shown in FIG. 13 were used as the tags to be pasted on the books 30.

### Comparative Example 5

In Comparative Example 5, the measurement was performed under the same condition as in Example 5 except that RFID tags 101 having the existing conductor pattern shown in FIG. 13 were used as the tags to be pasted on the books 30.

### Example 6

In Example 6, the measurement was performed under the same condition as in Example 4, except that the RFID tag 1B having the conductor pattern of the second modified example shown in FIG. 7, that is, the pattern without the pair of strips 232A and 232C among the four strips, were used as the tags to be pasted on the books 30.

### Example 7

In Example 7, the measurement was performed under the same condition as in Example 4 except that RFID tags 1C having the conductor pattern of the third modified example shown in FIG. 8, that is, the pattern without the four strips 232A to 232D, were used as the tags to be pasted on the books 30.

### Results of the Second Test

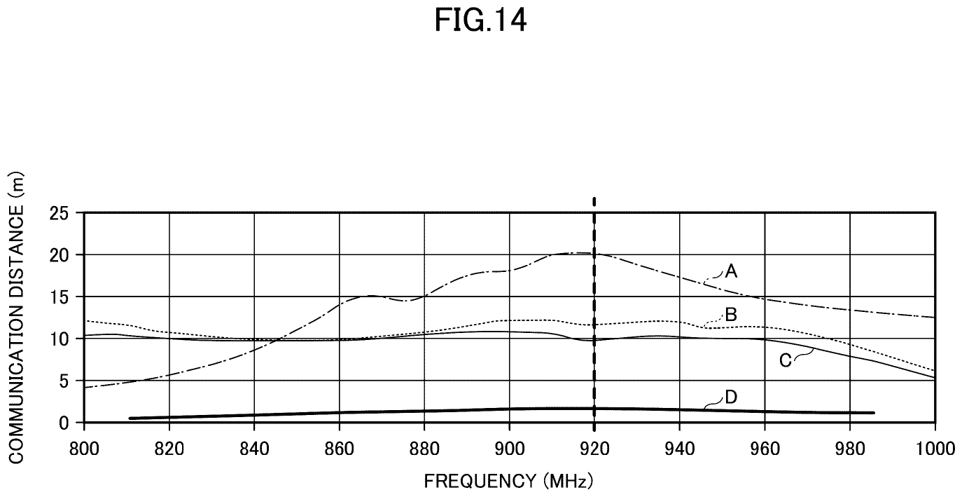

FIG. 14 is a diagram showing the frequency characteristics of Comparative Example 4. The horizontal axis of the diagram represents the frequency (MHz) of radio waves for wireless communication, and the vertical axis represents the communicable distance from the RFID tag 101 to the first antenna 51. In the diagram, a dot-and-dash line graph A indicates the characteristics of the RFID tag 101 alone, a dotted line graph B indicates the characteristics in the case where the number of books 30 placed in a stack was one, a solid line graph C indicates the characteristics in the case where the number of books 30 placed in a stack was two, and a bold solid line graph D indicates the characteristics in the case where the number of books 30 placed in a stack was eleven.

In FIG. 14, a position of a predetermined frequency of 920 MHz included in the UHF band is indicated by a bold dotted line. As shown in FIG. 14, in Comparative Example 4, when the frequency was 920 MHz, the communicable distance was approximately 20.0 m in the case of the tag alone, approximately 12.0 m in the case of one book, approximately 10.0 m in the case of two books being stacked, and approximately 2.0 m in the case of eleven books being stacked.

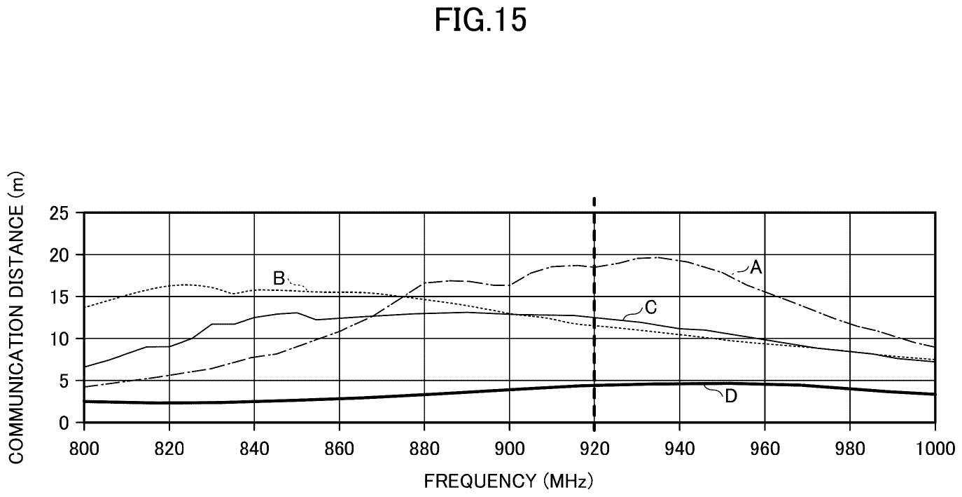

FIG. 15 is a diagram showing the frequency characteristics of Example 4. The horizontal axis of the diagram represents the frequency (MHz) of radio waves for wireless communication, and the vertical axis represents the communicable distance from the RFID tag 1 to the first antenna 51. The particulars of each graph in FIG. 15 are the same as in FIG. 14.

As shown in FIG. 15, in Example 4, when the frequency was 920 MHz, the communicable distance was approximately 18.5 m in the case of the tag alone, approximately 12.5 m in the case of one book, approximately 13.0 m in the case of two books being stacked, and approximately 4.5 m in the case of eleven books being stacked.

The test results shown in FIGS. 14 and 15 indicate that use of the conductor pattern of the inlay 2 of the RFID tag 1 of the present embodiment succeeded in increasing the communicable distance as compared with the existing RFID tag 101, and particularly in increasing the communicable distance in the UHF band.

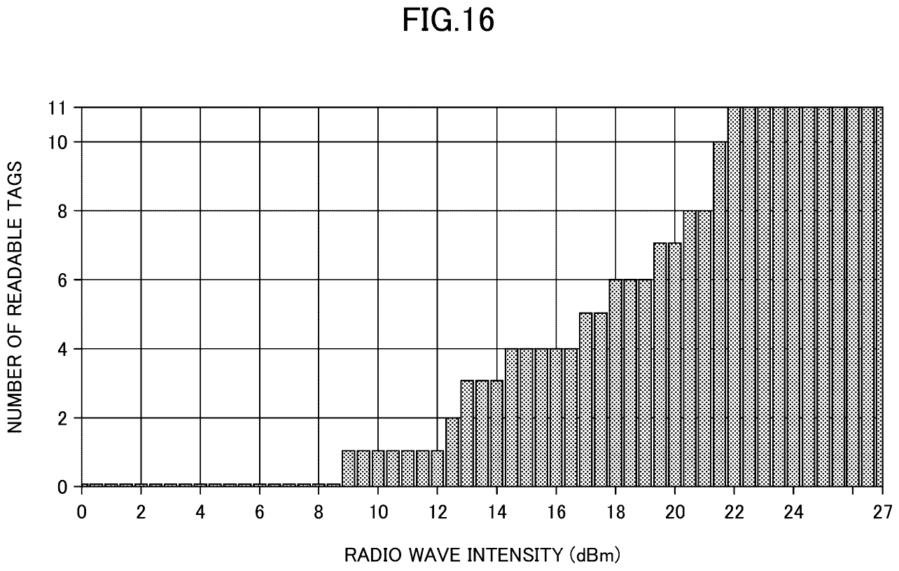

FIG. 16 is a diagram showing changes in the number of readable tags in Comparative Example 5. The horizontal axis of the diagram represents the radio wave intensity (dBm) of radio waves for wireless communication, and the vertical axis represents the number of RFID tags 101 from which the first antenna 51 was able to read information. As shown in FIG. 16, in Comparative Example 5, all of the eleven RFID tags 101 could be read when the radio wave intensity was 22 dBm or higher.

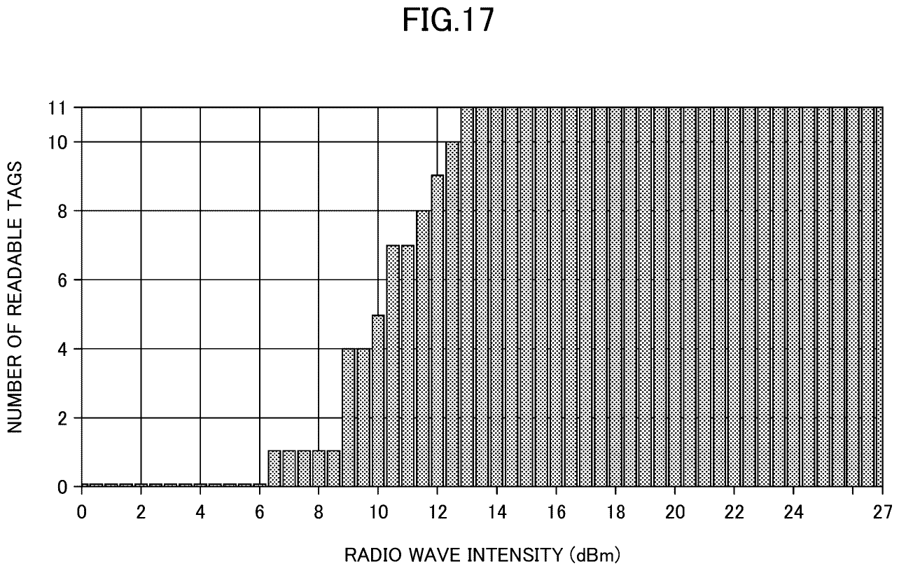

FIG. 17 is a diagram showing changes in the number of readable tags in Example 5. The horizontal axis of the diagram represents the radio wave intensity (dBm) of radio waves for wireless communication, and the vertical axis represents the number of RFID tags 1 from which the first antenna 51 was able to read information. As shown in FIG. 17, in Example 5, all of the eleven RFID tags 1 could be read when the radio wave intensity was 13 dBm or higher.

The test results shown in FIGS. 16 and 17 indicate that use of the conductor pattern of the inlay 2 of the RFID tag 1 of this embodiment succeeded in lowering the radio wave intensity at which all of the RFID tags 1 pasted on the plurality of books 30 laid on their side could be read, as compared with the existing RFID tag 101. That is, because the tag succeeded in being read at a lower radio wave intensity, it was indicated to be possible to reduce the effect on the communication performance due to the moisture contained in the sheets of paper, stacked around the RFID tag 1, of a book 30 serving a pasting target, and the effect on the communication performance due to close positioning of RFID tags pasted on a plurality of books 30 serving as pasting targets when the pasting targets were stacked.

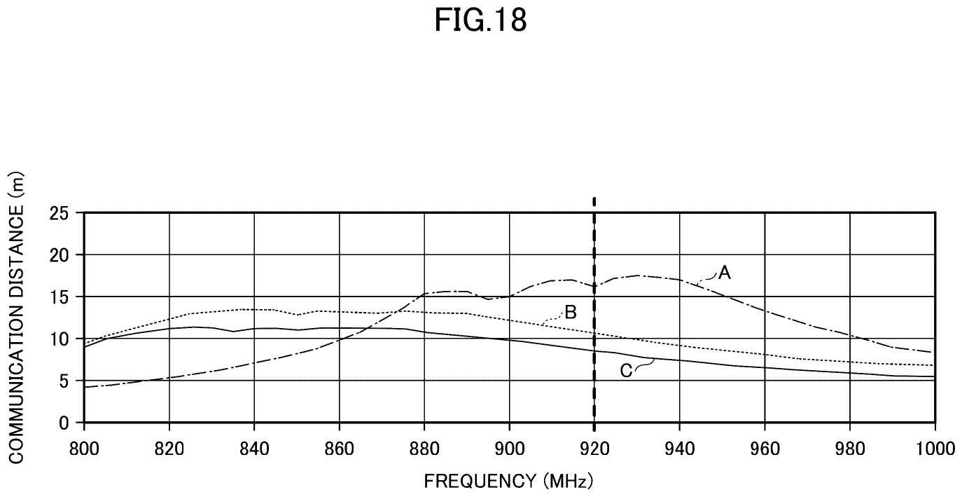

FIG. 18 is a diagram showing the frequency characteristics of Example 6. The particulars of FIG. 18 are the same as in FIG. 15. As shown in FIG. 18, in Example 6, when the frequency was 920 MHz, the communicable distance was approximately 16.0 m in the case of the tag alone, approximately 11.0 m in the case of one book, and approximately 8.5 m in the case of two books being stacked. In addition, although not shown in FIG. 18, the communicable distance was approximately 2.0 m in the case of eleven books being stacked.

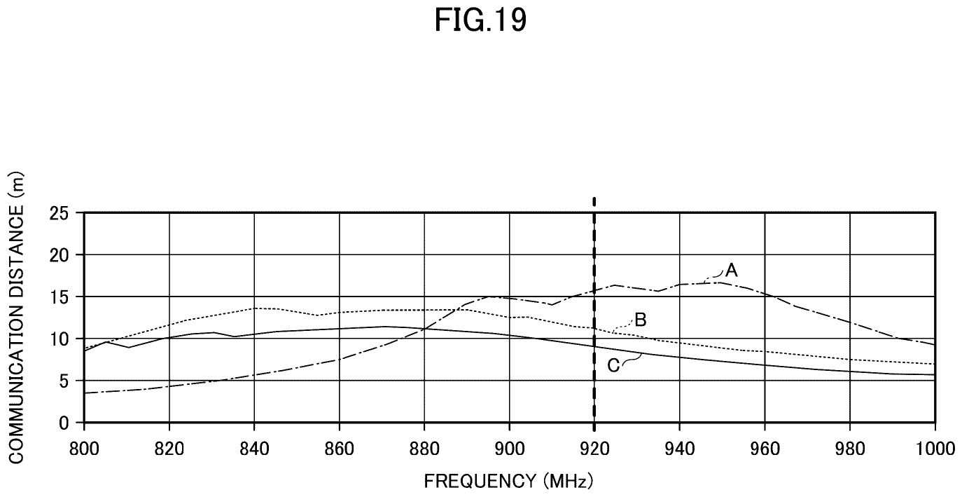

FIG. 19 is a diagram showing the frequency characteristics of Example 7. The particulars of FIG. 19 are the same as in FIG. 15. As shown in FIG. 19, in Example 7, when the frequency was 920 MHz, the communicable distance was approximately 16.0 m in the case of the tag alone, approximately 11.5 m in the case of one book, and approximately 9.0 m in the case of two books being stacked. Although not shown in FIG. 19, the communicable distance was approximately 2.0 m in the case of eleven books being stacked.

From the test results shown in FIGS. 18 and 19, the configuration that was free of a pair of strips of the two pairs of strips of the conductor pattern of the inlay 2 of the present embodiment like the RFID tags 1A and 1B of the first modified example and the second modified example illustrated in FIGS. 6 and 7, and the configuration that was free of the four strips of the conductor pattern of the inlay 2 of the present embodiment like the RFID tag 1C of the third modified example illustrated in FIG. 8 were also able to secure a communicable distance similar to that of the existing RFID tag 101. Therefore, it was indicated that no deterioration in the communication performance occurred by these configurations.

As described above, from the results of the second test, when the RFID tags were pasted on books 30, the conductor pattern of the RFID tag 1 of the present embodiment was able to increase the communicable distance and to lower the radio wave intensity necessary for tag reading, as compared with the existing conductor pattern of the RFID tag 101 of Comparative Examples shown in FIG. 13. Therefore, it was indicated the conductor pattern of the RFID tag of the present embodiment was not readily affected by moisture contained in the pages of the book 30 serving as the pasting target and by close positioning of RFID tags pasted on a plurality of pasting target books 30, and was able to inhibit deterioration in the communication performance.

The present embodiment has been described with reference to the specific examples. However, the present disclosure is not limited to these specific examples. Versions of these specific examples that are appropriately modified by a person skilled in the art are also included in the scope of the present disclosure as long as they have the features of the present disclosure. The elements included in the specific examples described above, and the positioning, the condition, the shape, and the like of the elements are not limited to the ones shown in the examples, and may be changed appropriately. The combinations of the elements included in each of the specific examples described above may be changed appropriately as long as no technical conflict occurs.

Regarding the foregoing description, the following items are further disclosed.

### Appendix 1

An RFID tag, including:
an IC chip in which identification information is recorded;
a loop-shaped conductor formed in an annular shape including a pair of opposite sides that extend in a shorter direction of the RFID tag and are situated to face both ends of the RFID tag in a longer direction of the RFID tag, the loop-shaped conductor being connected to the IC chip; and
a pair of rectangular conductors extending from the pair of opposite sides to both sides in the longer direction and formed in a rectangular shape.

### Appendix 2

The RFID tag according to Appendix 1,
wherein each of the pair of rectangular conductors includes:
a protrusion protruding from at least one of both ends of the rectangular conductor in the shorter direction to an outer side of the loop-shaped conductor in the shorter direction; and
a strip protruding from the protrusion toward a center in the longer direction along the longer direction, and formed in a strip shape.

### Appendix 3

The RFID tag according to Appendix 2,
wherein the loop-shaped conductor includes a pair of second opposite sides extending in the longer direction and situated to face both ends of the RFID tag in the shorter direction, and
the strip includes a pair of strips protruding from the protrusions of the pair of rectangular conductors on one of the pair of second opposite sides.

### Appendix 4

The RFID tag according to Appendix 3,
wherein the strip includes another pair of strips protruding from the protrusions of the pair of rectangular conductors on the other of the pair of second opposite sides.

### Appendix 5

The RFID tag according to any one of Appendices 2 to 4,
wherein the strip is formed so as not to overlap a portion of the loop-shaped conductor at which the IC chip is installed when viewed in the shorter direction.

This international application claims priority based on Japanese Patent Application No. 2022-110295 filed Jul. 8, 2022, and the entire contents of Japanese Patent Application No. 2022-110295 are incorporated herein by reference.

### Reference Signs List

1, 1A, 1B, 1C RFID tag
21 IC chip
22 loop-shaped conductor
221A, 221B shorter sides (a pair of opposite sides)
222A, 222B longer sides (a pair of second opposite sides)
23A, 23B a pair of rectangular conductors
231A, 231B, 231C, 231D protrusion
232A, 232B, 232C, 232D strip

1. An RFID tag, comprising:
an IC chip in which identification information is recorded;
a loop-shaped conductor formed in an annular shape including a pair of opposite sides that extend in a shorter direction of the RFID tag and are situated to face both ends of the RFID tag in a longer direction of the RFID tag, the loop-shaped conductor being connected to the IC chip; and
a pair of rectangular conductors extending from the pair of opposite sides to both sides in the longer direction and formed in a rectangular shape.

2. The RFID tag according to claim 1,
wherein each of the pair of rectangular conductors includes:
a protrusion protruding from at least one of both ends of the rectangular conductor in the shorter direction to an outer side of the loop-shaped conductor in the shorter direction; and
a strip protruding from the protrusion toward a center in the longer direction along the longer direction, and formed in a strip shape.

3. The RFID tag according to claim 2,
wherein the loop-shaped conductor includes a pair of second opposite sides extending in the longer direction and situated to face both ends of the RFID tag in the shorter direction, and
the strip includes a pair of strips protruding from the protrusions of the pair of rectangular conductors on one of the pair of second opposite sides.

4. The RFID tag according to claim 3,
wherein the strip includes another pair of strips protruding from the protrusions of the pair of rectangular conductors on the other of the pair of second opposite sides.

5. The RFID tag according to claim 2,
wherein the strip is formed so as not to overlap a portion of the loop-shaped conductor at which the IC chip is installed when viewed in the shorter direction.
